(19) United States
(12) Patent Application Publication
(10) Pub. No.: US 2022/0405761 A1
(43) Pub. Date: Dec. 22, 2022

(54) SYSTEM AND METHOD FOR ERROR DETECTION AND NOTIFICATION OF A STORAGE MEDIUM

(71) Applicant: Bank of America Corporation, Charlotte, NC (US)

(72) Inventor: Siten Sanghvi, Westfield, NJ (US)

(21) Appl. No.: 17/350,256

(22) Filed: Jun. 17, 2021

(51) Int. Cl. G06Q 20/40; G06Q 40/02; G06Q 20/32; H04L 29/06

(52) U.S. Cl. CPC G06Q 20/4093; G06Q 40/02; G06Q 20/3223; H04L 63/08; G06Q 20/341

(57) ABSTRACT

A system for error detection and notification that a storage medium of a first card is defective comprises an apparatus and a first server. The apparatus is configured to receive the storage medium of the first card. The apparatus comprises a first processor configured to receive data from the storage medium as the storage medium is inserted into the apparatus, wherein the received data is encoded into the storage medium. The first processor is configured to determine that the received data is incomplete and display a first output requesting authorization to issue a second card. The first processor is configured to transmit data to a communication network, wherein the transmitted data comprises user input authorizing issuance of the second card and requested data associated with the first card. The first server is configured to verify issuance of the second card, wherein the first server is communicatively coupled to the apparatus.

### TECHNICAL FIELD

The present disclosure relates generally to determining whether a storage medium comprises a defect. More particularly, in certain embodiments, the present disclosure is related to a system and method for error detection and notification of a storage medium.

### BACKGROUND

Users often complete transactions by inserting an object into an apparatus capable of receiving the object, where the object includes a storage medium, and where the apparatus is configured to access the storage medium. Over time, the storage medium can be damaged from a physical occurrence, such as through a scratch. The physical damage to the storage medium can affect how the apparatus accesses the data encoded within the storage medium. Alternatively, the data encoded within the storage medium may be corrupt to where the apparatus configured to receive the encoded data is not able to access the encoded data. In both cases, the apparatus is not able to receive the necessary encoded data.

### SUMMARY

The present disclosure provides for a system for image analysis for physical defect detection of a storage medium of a first card and a system for error detection and notification that a storage medium of a first card is defective. As a storage medium is inserted into an apparatus configured to receive data from the storage medium, the apparatus may determine that either there is a physical defect on the storage medium or that a received data set from the storage medium is incomplete. The apparatus displays outputs to a user associated with the first card for authorization to issue a second card to replace the first card. The apparatus transmits data to a server to determine an account associated with the first user, and the server transmits a secondary authorization request to the user.

In an embodiment, a system for error detection and notification that a storage medium of a first card is defective comprises an apparatus configured to receive the storage medium of the first card. The apparatus comprises a first memory and a first processor, wherein the first memory is operable to store data received from the storage medium, and wherein the first processor is communicatively coupled to the first memory and configured to receive data from the storage medium as the storage medium is at least partially inserted into the apparatus, wherein the received data is encoded into the storage medium. The first processor is further configured to determine that the received data is incomplete and in response to determining that the received data is incomplete, display a first output requesting authorization to issue a second card. The first processor is further configured to receive authorization to issue the second card through a user interface and in response to receiving authorization to issue the second card through the user interface, display a second output requesting data associated with the first card. The first processor is further configured to receive the requested data through the user interface of the apparatus and transmit data to a communication network, wherein the transmitted data comprises the user input authorizing issuance of the second card and the requested data associated with the first card.

The system further comprises a first server configured to verify issuance of the second card, wherein the first server is communicatively coupled to the apparatus. The first server comprises a second memory operable to store an account associated with a first user that is associated with the first card. The first server further comprises a second processor operably coupled to the second memory and configured to receive account data for the first user that is based at least in part upon the transmitted data comprising the user input authorizing issuance of the second card and the requested data associated with the first card, determine the account associated with the first user based on the received account data for the first user, and transmit a secondary authorization request for verification to initiate issuance of the second card.

Previous technology used for receiving and processing the data from the storage medium suffers from disadvantages. For example, this disclosure recognizes that the state or condition of the storage medium affects operability of the apparatus configured to receive data from the storage medium. For example, the apparatus may not be able to process the storage medium if there is a scratch disposed within or across the storage medium. In another example, the storage medium may be corrupt to where the apparatus cannot read the data encoded in the storage medium. In both examples, the user associated with the storage medium may not be aware that the storage medium is defective or inoperable.

Certain embodiments of this disclosure provide unique solutions to the technical problems identified above by providing a system for image analysis for physical defect detection of a storage medium of a first card and a system for error detection and notification that a storage medium of a first card is defective. For example, the disclosed system provides several technical advantages, which include: 1) determining that the storage medium comprises a physical defect; 2) determining that the data received from the storage medium is incomplete; 3) requesting authorization to replace the storage medium; and 4) a secondary authorization request transmitted via a communication preference specified by the associated user. The disclosed system may detect a physical defect through the use of an optical sensor incorporated into an apparatus configured to receive the storage medium. The disclosed system may further determine that a received data set is incomplete, where this determination may vary based on whether the storage medium is disposed in a chip or on a magnetic stripe. The apparatus can give an option to the user to decide that a replacement should be issued. The apparatus may then communicate with one or more serves to determine account data and an account associated with the user in order to issue the replacement. As such, this disclosure may improve the function of computing systems used to detect defective storage mediums received by an apparatus.

In some embodiments, improvements provided by this disclosure are incorporated into the practical application of the capacity for an apparatus to determine whether received data from a storage medium is incomplete, where the storage medium is disposed on a card (for example, a credit card or debit card). The apparatus, such as a card reader or ATM, is configured to receive data from the storage medium as the storage medium is inserted into the apparatus. The data encoded within the storage medium can include a credit card number, security code, expiration date, zip code, a name of a user associated with the credit card, and combinations thereof. In situations wherein there may not be visual indicators of a problem with the storage medium but the storage medium is corrupted, the apparatus determines that the storage medium cannot perform a transaction between the apparatus and the card. This determination can be dependent on the form of the storage medium. For example, there may be separate factors in determining whether the received data may be incomplete if the storage medium is a magnetic stripe or disposed in a chip on the card. The apparatus can alert a user that the storage medium is defective when the received data from the storage medium is incomplete by transmitting an alert to the user through a suitable communication preference, such as email or text messaging.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts. FIG. 1 is a schematic diagram of an example system detecting a defect of a storage medium;

FIG. 2 is a block diagram of an example apparatus of the system of FIG. 1; and

FIG. 3 is a flow diagram illustrating an example operation of the system of FIG. 1.

### DETAILED DESCRIPTION

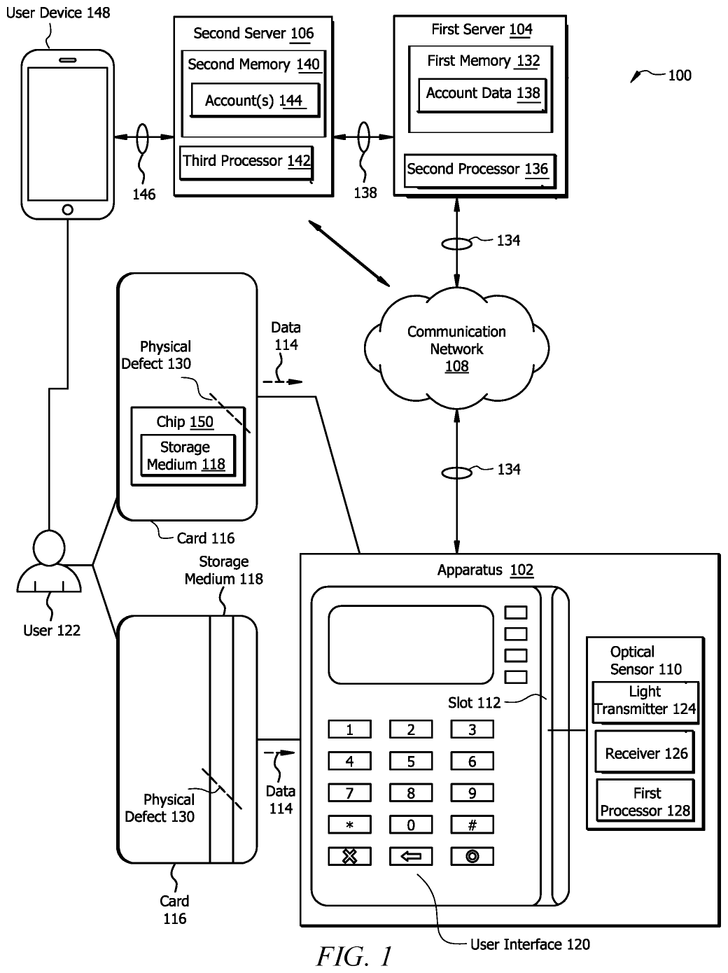

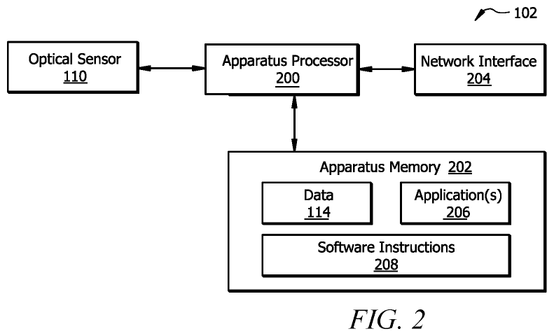

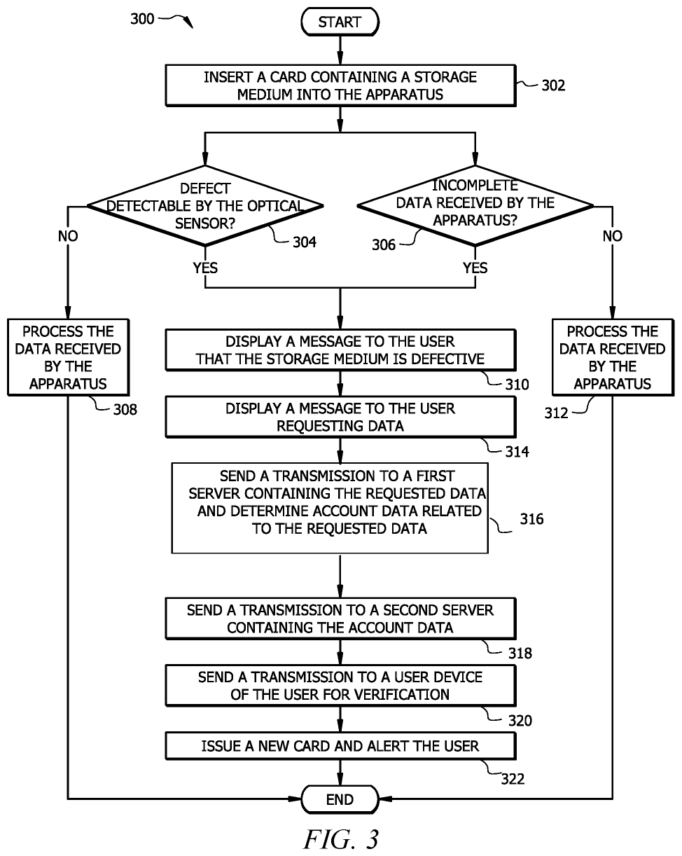

This disclosure provides solutions to the aforementioned and other problems of previous technology by determining whether a storage medium comprises a physical defect and whether an apparatus receives incomplete data from the storage medium. FIG. 1 is a schematic diagram of an example system for detecting a defect in a storage medium. FIG. 2 is a block diagram of an example apparatus of the system of FIG. 1. FIG. 3 is a flow diagram illustrating an example operation of the system of FIG. 1.

### Example System for Detecting a Defect in a Storage Medium

FIG. 1 illustrates a schematic diagram of an example system 100 for detecting a defect in a storage medium. The system 100 may include an apparatus 102, a first server 104, and a second server 106. The system 100 may be communicatively coupled to a communication network 108 and may be operable to transmit data between the apparatus 102, first server 104, and second server 106 through the communication network 108. In general, the apparatus 102 may comprise an optical sensor 110 configured to operate in proximity to a slot 112 of the apparatus 102. In turn, the slot 112 may receive an external object comprising a storage medium (e.g., a credit or debit card that is inserted into the slot 112). As the external object is inserted into the slot 112, the apparatus 102 may determine that a defect is present in the storage medium of the external object or that the storage medium is defective. For example, the optical sensor 110 of the apparatus 102 may be operable to produce a light to be reflected off of the storage medium once the external object is inserted into the slot 112, receive and process the reflected light, and determine that a physical defect is present on the storage medium. In this example, the apparatus 102 may receive an indication from the optical sensor 110 that the storage medium contains a physical defect, request authorization to issue a replacement for the external object, and transmit the authorization to the first server 104 through the communication network 108 for subsequent operations. In another example, the apparatus 102 may receive data 114 from the storage medium as the external object is at least partially inserted into the slot 112, determine that the received data 114 is incomplete, request authorization to issue a replacement for the external object, and transmit the authorization to the first server 104 through the communication network 108 for subsequent operations.

The apparatus 102 may generally be any suitable computing device operable to receive an object, such as a card 116 (e.g., a credit card, debit card, or any other suitable payment card), comprising a storage medium 118 and to process data contained within the storage medium 118. For example, the apparatus 102 may be a card reader or other point-of-sale device that includes a user interface 120 (e.g., a touchscreen, a display and keypad, and/or the like) operable to provide user input and display data. The apparatus 102 may be configured to transmit signals to communicatively connect to the communication network 108; to receive, process, and store data 114 from the storage medium 118; to receive a signal from the optical sensor 110; to display data to a user 122 through the user interface 120; to transmit received authorization to issue a new card 116 to the first server 104; and any combinations thereof. The apparatus 102 may comprise the slot 112 disposed at any suitable location on the apparatus 102, where the slot 112 may be configured to receive the storage medium 118 as the card 116 is at least partially inserted into the apparatus 102. The slot 112 may be disposed vertical in relation to the apparatus 102, horizontal in relation to the apparatus 102, or some combination thereof. An example apparatus 102 and its operations using a respective processor, memory, and interface is described below with respect to FIGS. 2-3.

The optical sensor 110 may generally be any suitable device operable to convert light into an electronic signal. Without limitations, the optical sensor 110 may be any suitable photoelectric sensor, image sensor, and any combination thereof. The optical sensor 110 may be operable to produce a light to be reflected off of a surface, wherein the optical sensor 110 may be further operable to process the reflected light. The optical sensor 110 may be configured to determine a distance, absence, and/or presence of an object based on the processed, reflected light. The optical sensor 110 may comprise a light transmitter 124, a receiver 126, and a first processor 128. The light transmitter 124 may be operable to produce a light to be directed to the storage medium 118, wherein the produced light reflects off of the storage medium 118. The receiver 126 may be operable to receive the reflected light from the storage medium 118. The first processor 128 may be configured to process the reflected light as electronic signals and to determine that the storage medium 118 comprises a physical defect 130 based upon the processed electronic signals. Without limitations, the physical defect 130 may be a scratch, a stain, a dent, a protrusion, solidified substances on the storage medium 118, and any combinations thereof

The optical sensor 110 may be configured to be communicatively coupled to the apparatus 102 through a wired or wireless connection. The optical sensor 110 may further be incorporated into the apparatus 102 or coupled to the apparatus 102. In particular examples, the optical sensor 110 may be configured to operate in proximity to the slot 112 to direct the produced light onto the storage medium 118 as the storage medium 118 is inserted into the apparatus 102. Without limitations, the optical sensor 110 may be incorporated into or coupled to the apparatus 102 through the use of any suitable means, including fasteners, snap-fit means, reactionary spring forces, adhesives, brazing, or any combinations thereof.

The communication network 108 may facilitate communication within the system 100. This disclosure contemplates the communication network 108 being any suitable network operable to facilitate communication between the apparatus 102, the first server 104, and the second server 106. Communication network 108 may include any interconnecting system capable of transmitting audio, video, signals, data, messages, or any combination of the preceding. Communication network 108 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The first server 104 is generally a suitable server (e.g., including a physical server and/or virtual server) operable to store data in a first memory 132 and/or provide access to application(s) or other services. For example, the first server 104 may be a database operable to receive a transmission 134 from the apparatus 102 comprising user input authorizing issuance of a second card to replace the card 116 and requested data from the user 122 associated with the card 116. Once the first server 104 receives the transmission 134 from the apparatus 102, a second processor 136, associated with the first server 104, may determine account data 138 associated with a particular card 116 based on the received transmission 134. For example, the account data 138 may be stored in the first memory 132, wherein the account data 138 may be individually associated with one of a plurality of cards 116. The second processor 136 may be communicatively coupled to the first memory 132 and may access the first memory 132 to determine the account data 138 for one of the plurality of cards 116 stored in the first memory 132. The second processor 136 may be further operable to transmit the determined account data 138 to the second server 106.

The second server 106 is generally a suitable server (e.g., including a physical server and/or virtual server) operable to store data in a second memory 140 and/or provide access to application(s) or other services. For example, the second server 106 may be a database operable to receive the account data 138 from the first server 104. Once the second server 106 receives the account data 138, a third processor 142, associated with the second server 106, may determine an account 144 associated with the user 122 that is associated with the card 116 based on the received account data 138. For example, the one or more accounts 144 may be stored in the second memory 140, wherein each of the one or more accounts 144 may be individually associated with a particular user 122. The third processor 142 may be communicatively coupled to the second memory 140 and may access the second memory 140 to determine the account 144 the user 122 associated with the card 116. The third processor 142 may be further operable to transmit a secondary authorization request for verification to initiate issuance of a second card to replace the card 116. In embodiments, the user 122 may receive the secondary authorization request via a user device 148 (for example, a mobile device). The secondary authorization request may be transmitted through a communication preference based, at least in part, upon the account 144 associated with the user 122. Without limitations, the user 122 may have designated within the account 144 to receive any suitable communications through an email address associated with the account 144, a phone number associated with the account 144, or an application on the user device 148 associated with the account 144.

### Example Operation of the System

The apparatus 102 of the system 100 may be disposed about any suitable location for convenience to the user 122 to complete a transaction. For example, the apparatus 102 may be a card reader or other point-of-sale device disposed at a gas station pump and operable to complete the transaction of the user 122 paying for the gas station pump to dispense a flow of gasoline. In another example, the apparatus 102 may be a card reader or other point-of-sale device disposed within a store and operable to complete the transaction of the user 122 for purchasing an item. While the present examples are directed to the use at a gas station pump or a store, the system 100 is not limited to this use. In other examples, the system 100 may be utilized at any suitable location where card readers or other point-of-sale devices may be used, such as at automated teller machines (ATMs), payment kiosks, portable card readers, and the like.

In an example operation of the system 100, as illustrated in FIG. 1, the user 122 may insert the card 116 containing the storage medium 118 into the apparatus 102. The card 116 may be at least partially inserted into the slot 112 of the apparatus 102. As the card 116 is inserted, the apparatus 102 may receive the data 114 that has been encoded into the storage medium 118. In embodiments, the storage medium 118 may be a magnetic stripe, or “magstripe”, disposed on the card 116 wherein the data 114 encoded into the magstripe is contained in one or more tracks. The one or more tracks may be the physical location within the storage medium 118 where data 114 has been encoded.

In embodiments, each of the one or more tracks may comprise different recording densities, wherein the recording density is the quantity of bits of data 114 per unit of length (e.g., 210 bits per inch). For example, one of the one or more tracks may comprise a higher recording density than a subsequent tracks, where the track with the higher recording density may contain more data 114 than the track with a lower recording density.

In another example, the data 114 may be stored in a storage medium 118 disposed within a chip 150 in the card 116 rather than within the magstripe on the card 116. The chip 150 may be an embedded integrated circuit chip capable of providing personal identification, authentication, data storage, application processing, and any combinations thereof. The card 116 comprising the storage medium 118 within the chip 150 may be configured to transmit data 114 to a terminal apparatus 102 that is chip-enabled. In this example, the chip 150 may be further operable to generate and transmit an authorization code to the apparatus 102 that authorizes the apparatus 102 to access the storage medium 118.

The storage medium 118 may contain data 114 associated to the individual user 122. Without limitations, the data 114 may include personal information of the individual user 122, such as name, credit card number, expiration date, security code, zip code, and combinations thereof. The apparatus 102 may be operable to receive data 114 from each of the one or more tracks of the magstripe, from the chip 150, and a combination thereof.

With reference to both examples of the storage mediums 118, the apparatus 102 may be configured to determine both external and internal problems with the storage medium 118. In embodiments wherein the apparatus 102 determines external problems with the storage medium 118, the optical sensor 110 may be actuated to detect a physical defect 130. In embodiments wherein the apparatus 102 determines internal problems with the storage medium 118, the apparatus 102 may determine whether the received data 114 is incomplete.

In the first embodiment regarding the optical sensor 110, the optical sensor 110 may be operable to produce a light with the light transmitter 124 to be directed to the storage medium 118 as the storage medium 118 is inserted into the slot 112. The produced light may reflect off of the storage medium 118, wherein the optical sensor 110 may receive the reflected light with the receiver 126. The optical sensor 110 may then be operable to process the reflected light as electronic signals with the first processor 128, where the first processor 128 may determine that the storage medium 118 comprises the physical defect 130 based upon the processed electronic signals. The first processor 128 may transmit a signal to the apparatus 102 containing an indication that the storage medium 118 comprises the physical defect 130.

In the second embodiment, the apparatus 102 may receive the data 114 from the storage medium 118. The received data 114 may comprise the name of the user 122, a credit card number, an expiration date, a security code, a zip code, an authorization code from the chip 150, and any combinations thereof. The apparatus 102 may be operable to determine whether the received data 114 is incomplete. The received data 114 may be designated as incomplete if the credit card number was not received from the storage medium 118, the security code was not received from the storage medium 118, the expiration date was not received from the storage medium 118, the authorization code was not received from the chip 150, a portion of the credit card number was not received, a portion of the security code was not received, a portion of the authorization code was not received, a portion of the expiration date was not received, or any combination thereof.

With reference to both embodiments, the apparatus 102 may then be operable to display a first output requesting authorization to issue a second card to replace the card 116. The user 122 may input authorization through the user interface 120 of the apparatus 102. The apparatus 102 may receive the authorization to issue the second card through the user interface 120. In response to receiving authorization to issue the second card through the user interface 120, the apparatus 102 may display a second output requesting data associated with the card 116. The user 122 may input the requested data through the user interface 120 of the apparatus 102, and the apparatus 102 may receive the requested data through the user interface 120. In embodiments, the requested data may be similar to the categories of data analyzed by the apparatus 102 in determining whether the received data 114 is incomplete. For example, the second display may request the user 122 to input the credit card number, expiration date, security code, zip code, or a combination thereof that is associated with the card 116. The apparatus 102 may send a transmission 134 comprising the user input authorizing issuance of a second card to replace the card 116 and the requested data from the user 122 associated with the card 116 to the communication network 108.

The first server 104 may receive the transmission 134 via the communication network 108 and may determine account data 138 associated with a particular card 116 based on the received transmission 134. The first server 104 may transmit, via the second processor 136, the determined account data 138 to the second server 106. Once the second server 106 receives the account data 138, the second server 106 may determine the account 144 associated with the user 122 based on the received account data 138. The second server 106 may be further operable to transmit a secondary authorization request to the user 122 for verification to initiate issuance of the second card to replace the card 116. In these embodiments, the secondary authorization request may be transmitted through a communication preference based upon the account 144 associated with the user 122. In these embodiments, the apparatus 102, first server 104, and second server 106 may be communicatively coupled to each other over the communication network 108.

### Example Apparatus

FIG. 2 is an example of the apparatus 102 of FIG. 1. The apparatus 102 may include an apparatus processor 200, an apparatus memory 202, and a network interface 204. The apparatus 102 may be configured as shown or in any other suitable configuration.

The apparatus processor 200 comprises one or more processors operably coupled to the apparatus memory 202. The apparatus processor 200 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The apparatus processor 200 may be a programmable logic device, a microcontroller, a microprocessor, or any suitable combination of the preceding. The apparatus processor 200 is communicatively coupled to and in signal communication with the apparatus memory 202 and the network interface 204. The one or more processors are configured to process data and may be implemented in hardware or software. For example, the apparatus processor 200 may be 8-bit, 16-bit, 32-bit, 64-bit or of any other suitable architecture. The apparatus processor 200 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the function disclosed herein, such as some or all of those described with respect to FIGS. 1-3. In some embodiments, the function described herein is implemented using logic units, FPGAs, ASICs, DSPs, or any other suitable hardware or electronic circuitry.

As illustrated in FIG. 2, the apparatus processor 200 may be communicatively coupled to and in signal communication with the optical sensor 110. As described above, the optical sensor 110 may comprise the first processor 128 (referring to FIG. 1) operable to determine whether the storage medium 118 (referring to FIG. 1) comprises the physical defect 130 (referring to FIG. 1) based at least in part upon the processed electronic signals. Similar to the apparatus processor 200, the first processor 128 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The first processor 128 may be a programmable logic device, a microcontroller, a microprocessor, or any suitable combination of the preceding. The one or more processors are configured to process data and may be implemented in hardware or software. For example, the first processor 128 may be 8-bit, 16-bit, 32-bit, 64-bit or of any other suitable architecture. The first processor 128 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the function disclosed herein, such as some or all of those described with respect to FIGS. 1-3. In some embodiments, the function described herein is implemented using logic units, FPGAs, ASICs, DSPs, or any other suitable hardware or electronic circuitry.

The apparatus memory 202 is operable to store any of the information described with respect to FIGS. 1-3 along with any other data, instructions, logic, rules, or code operable to implement the function(s) described herein when executed by apparatus processor 200. For example, the apparatus memory 202 may store the data 114 received from the storage medium 118 (referring to FIG. 1), code for application(s) 206, and/or software instructions 208, which are described below with respect to FIG. 3. The apparatus memory 202 comprises one or more disks, tape drives, or solid-state drives, and may be used as an over-flow data storage device, to store programs when such programs are selected for execution, and to store instructions and data that are read during program execution. The apparatus memory 202 may be volatile or non-volatile and may comprise read-only memory (ROM), random-access memory (RAM), ternary content-addressable memory (TCAM), dynamic random-access memory (DRAM), and static random-access memory (SRAM).

The network interface 204 is configured to enable wired and/or wireless communications. The network interface 204 is configured to communicate data between the apparatus 102 and other network devices, systems, or domain(s). For example, the network interface 204 may comprise a WIFI interface, a local area network (LAN) interface, a wide area network (WAN) interface, a modem, a switch, or a router. The apparatus processor 200 is configured to send and receive data using the network interface 204. The network interface 204 may be configured to use any suitable type of communication protocol as would be appreciated by one of ordinary skill in the art.

### Example Operations of the System for Detecting a Defect in a Storage Medium

FIG. 3 is a flow diagram illustrating an example method 300 of the system 100 of FIG. 1. The method 300 may be implemented using the apparatus 102, the first server 104, and the second server 106 of FIG. 1. The method 300 may begin at step 302 where the user 122 (referring to FIG. 1) may insert an object, such as the card 116 (referring to FIG. 1), containing the storage medium 118 (referring to FIG. 1) into the apparatus 102. As the card 116 is inserted into the apparatus 102, the apparatus 102 may be configured to receive at least a portion of the card 116, wherein the portion comprises the storage medium 118. In certain examples, the storage medium 118 may be the magstripe comprising one or more tracks, the storage medium 118 may be within the chip 150 (referring to FIG. 1), or a combination thereof. Once the card 116 is inserted into the apparatus 102, the method 300 may proceed to step 304, to step 306, or may proceed to both of steps 304, 306 concurrently.

At step 304, the apparatus 102 may determine whether the storage medium 118 comprises the physical defect 130 (referring to FIG. 1). During step 304, the optical sensor 110 (referring to FIG. 1) may produce a light with the light transmitter 124 (referring to FIG. 1) to be directed to the storage medium 118 as the storage medium 118 is inserted into the slot 112 (referring to FIG. 1). The produced light may reflect off of the storage medium 118, wherein the optical sensor 110 may receive the reflected light with the receiver 126 (referring to FIG. 1). The optical sensor 110 may process the reflected light as electronic signals with the first processor 128 (referring to FIG. 1), where the first processor 128 may determine that the storage medium 118 comprises the physical defect 130 based upon the processed electronic signals. The first processor 128 may produce an image based, at least in part, upon the processed electronic signals and may analyze the image to determine a presence of the physical defect 130. The first processor 128 may determine one or more boundaries of the storage medium 118 based, at least in part, upon the processed electronic signals and/or the produced image. If there is a contrast within the one or more boundaries of the storage medium 118 greater than a threshold (for example, 5%), the first processor 128 may determine that the storage medium 118 comprises the physical defect 130, wherein the physical defect 130 is indicative of the identified contrast within the boundaries of the storage medium 118. In embodiments, the contrast may be determined between magnitudes of sequential electronic signals, between magnitudes of pixels in the produced image, or combinations thereof. The first processor 128 may then transmit a signal to the apparatus 102 containing an indication that the storage medium 118 comprises the physical defect 130. If there is a determination that the storage medium 118 does not comprise the physical defect 130, the method 300 proceeds to step 308. Otherwise, the method 300 proceeds to step 310.

At step 308, the apparatus 102 may receive the data 114 from the storage medium 118. The apparatus 102 may further process the received data 114 to complete a transaction for the user 122. The method proceeds to end after step 308.

With reference back to step 306, the apparatus 102 may determine whether the storage medium 118 is internally defective where all of the data 114 is not received by the apparatus 102. The apparatus 102 may receive the data 114 from the storage medium 118 once the storage medium 118 is inserted into the slot 112 of the apparatus 102. The received data 114 may comprise the name of the user 122, a credit card number, an expiration date, a security code, a zip code, an authorization code from the chip 150, and any combinations thereof In embodiments, the apparatus 102 may not receive each of the credit card number, expiration date, security code, zip code, and authorization code. The apparatus processor 200 (referring to FIG. 2) may be operable to determine whether the received data 114 is incomplete. The received data 114 may be designated as incomplete if the credit card number was not received, the security code was not received, the expiration date was not received, the authorization code was not received, a portion of the credit card number was not received, a portion of the security code was not received, a portion of the authorization code was not received, a portion of the expiration date was not received, or any combination thereof In these embodiments, there may be an internal defect within the storage medium 118 and/or the chip 150 if the apparatus 102 receives data 114 that is incomplete. Without limitations, such internal defects may include failure with the circuitry of the chip 150. If there is a determination that the received data 114 is incomplete, the method 300 proceeds to step 312. Otherwise, the method 300 proceeds to step 310.

At step 312, the apparatus 102 may receive the data 114 from the storage medium 118. The received data 114 may be determined to be complete for further processing. Similar to step 308, the apparatus 102 may further process the received data 114 to complete a transaction for the user 122. The method proceeds to end after step 312.

At step 310, the apparatus processor 200 may display a first output through the user interface 120 (referring to FIG. 1) requesting authorization to issue a second card to replace the card 116. The user 122 may input authorization through the user interface 120 of the apparatus 102. The apparatus processor 200 may receive the user input authorizing the issuance of the second card through the user interface 120. The apparatus processor 200 may further instruct the apparatus memory 202 (referring to FIG. 2) to store the user input authorizing the issuance of the second card. At step 314, in response to receiving authorization to issue the second card through the user interface 120, the apparatus processor 200 may display a second output requesting data associated with the card 116. The user 122 may input the requested data through the user interface 120 of the apparatus 102, and the apparatus processor 200 may receive the requested data through the user interface 120. In embodiments, the requested data may be similar to the categories of data analyzed by the apparatus processor 200 in determining whether the received data 114 is incomplete. For example, the second display may request the user 122 to input the credit card number, expiration date, security code, zip code, or a combination thereof that is associated with the card 116. The apparatus processor 200 may further instruct the apparatus memory 202 to store the requested data.

At step 316, the apparatus processor 200 may send the transmission 134 (referring to FIG. 1) comprising the user input authorizing issuance of a second card to replace the card 116 and the requested data from the user 122 associated with the card 116 to the first server 104 (referring to FIG. 1) via the communication network 108 (referring to FIG. 1). The first server 104 may receive the transmission 134 and may determine the account data 138 (referring to FIG. 1) associated with a particular card 116 based on the received transmission 134. In embodiments, the first memory 132 (referring to FIG. 1) may be operable to store the account data 138, wherein the account data 138 may be individually associated with one of a plurality of cards 116. The second processor 136 (referring to FIG. 1) may access the first memory 132 to determine the account data 138 for one of the plurality of cards 116 stored in the first memory 132.

At step 318, the second processor 136 may transmit the determined account data 138 to the second server 106 (referring to FIG. 1). Once the second server 106 receives the account data 138, the second server 106 may determine the account 144 (referring to FIG. 1) associated with the user 122 based on the received account data 138. The one or more accounts 144 may be stored in the second memory 140 (referring to FIG. 1), wherein each of the one or more accounts 144 may be individually associated with a particular user 122. The third processor 142 (referring to FIG. 1) may access the second memory 140 to determine the account 144 of the user 122 associated with the card 116.

At step 320, the third processor 142 may transmit a secondary authorization request for verification to initiate issuance of a second card to replace the card 116. In embodiments, the user 122 may receive the secondary authorization request via the user device 148 (for example, a mobile device) (referring to FIG. 1). The secondary authorization request may be transmitted through a communication preference based, at least in part, upon the account 144 associated with the user 122. Without limitations, the user 122 may have designated within the account 144 to receive any suitable communications through an email address associated with the account 144, a phone number associated with the account 144, or an application on the user device 148 associated with the account 144 (referring to FIG. 1).

At step 322, if the user 122 provides a secondary authorization, the third processor 142 may receive the secondary authorization from the user 122. The third processor 142 may transmit instructions for further operations to initiate the issuance of the second card to replace the card 116. In further embodiments, the third processor 142 may transmit an alert to the user 122 once the second card has been issued. Once the third processor 142 transmits the alert, the method 300 proceeds to end.

While several embodiments have been provided in this disclosure, it should be understood that the disclosed system and method might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for error detection and notification that a storage medium of a first card is defective, comprising:
an apparatus configured to receive the storage medium of the first card, the apparatus comprising a first memory and a first processor, wherein the first memory is operable to store data received from the storage medium, and wherein the first processor is communicatively coupled to the first memory and configured to:
receive data from the storage medium as the storage medium is at least partially inserted into the apparatus, wherein the received data is encoded into the storage medium;
determine that the received data is incomplete;
in response to determining that the received data is incomplete, display a first output requesting authorization to issue a second card;
receive authorization to issue the second card through a user interface;
in response to receiving authorization to issue the second card through the user interface, display a second output requesting data associated with the first card;
receive the requested data through the user interface of the apparatus; and
transmit data to a communication network, wherein the transmitted data comprises the user input authorizing issuance of the second card and the requested data associated with the first card; and
a first server configured to verify issuance of the second card, wherein the first server is communicatively coupled to the apparatus, the first server comprising:
a second memory operable to:
store an account associated with a first user that is associated with the first card; and
a second processor operably coupled to the second memory and configured to:
receive account data for the first user that is based at least in part upon the transmitted data comprising the user input authorizing issuance of the second card and the requested data associated with the first card;
determine the account associated with the first user based on the received account data for the first user;
transmit a secondary authorization request to a user device associated with the first user for verification to initiate issuance of the second card; and
in response to receiving secondary authorization from the user device, transmit an alert to the user device once the second card has been issued.

2. The system of claim 1, wherein the storage medium is contained within a chip disposed on the first card, wherein the first processor is further configured to determine that the received data comprises a credit card number associated with the first card and an authorization code generated by the chip.

3. The system of claim 2, wherein the first processor is further configured to determine that the credit card number was not received from the storage medium, that the authorization code was not received from the storage medium, that a portion of the credit card number was not received from the storage medium, or that a portion of the authorization code was not received.

4. The system of claim 1, wherein the storage medium is a magstripe disposed on the first card, wherein the first processor is further configured to determine that the received data comprises a credit card number associated with the first card, a security code associated with the first card, and an expiration date associated with the first card.

5. The system of claim 4, wherein the first processor is further configured to determine that the credit card number was not received from the storage medium, that the security code was not received from the storage medium, that the expiration date was not received from the storage medium, that a portion of the credit card number was not received from the storage medium, that a portion of the authorization code was not received, or that a portion of the expiration date was not received.

6. The system of claim 1, wherein the secondary authorization request is transmitted by the second processor through a communication preference based at least in part upon the account associated with the first user.

7. The system of claim 6, wherein the communication preference is an email address associated with the account, a phone number associated with the account, or an application on a mobile device associated with the account.

8. A method for error detection and notification that a storage medium of a first card is defective, comprising:
receiving data from the storage medium as the storage medium is at least partially inserted into an apparatus, wherein the received data is encoded into the storage medium;
determining that the received data is incomplete;
in response to determining that the received data is incomplete, displaying a first output requesting authorization to issue a second card;
receiving authorization to issue the second card through a user interface;
in response to receiving authorization to issue the second card through the user interface, displaying a second output requesting data associated with the first card;
receiving the requested data through the user interface of the apparatus;
transmitting data to a communication network, wherein the transmitted data comprises the user input authorizing issuance of the second card and the requested data associated with the first card;
determining an account associated with a first user that is associated with the first card;
transmitting a secondary authorization request to a user device associated with the first user for verification to initiate issuance of the second card; and
in response to receiving secondary authorization from the user device, transmitting an alert to the user device once the second card has been issued.

9. The method of claim 8, wherein the secondary authorization request is transmitted by the second processor through a communication preference based at least in part upon the account associated with the first user.

10. The method of claim 9, wherein the communication preference is an email address associated with the account, a phone number associated with the account, or an application on a mobile device associated with the account.

11. The method of claim 8, wherein the storage medium is contained within a chip disposed on the first card.

12. The method of claim 11, wherein determining that the received data is incomplete comprises of determining that a credit card number was not received from the storage medium, that an authorization code was not received from the storage medium, that a portion of the credit card number was not received from the storage medium, or that a portion of the authorization code was not received.

13. The method of claim 8, wherein the storage medium is a magstripe disposed on the first card.

14. The method of claim 13, wherein determining that the received data is incomplete comprises of determining that a credit card number was not received from the storage medium, that a security code was not received from the storage medium, that an expiration date was not received from the storage medium, that a portion of the credit card number was not received from the storage medium, that a portion of the authorization code was not received, or that a portion of the expiration date was not received.

15. A non-transitory computer-readable medium comprising instructions that are configured, when executed by a first processor of an apparatus configured to receive a storage medium of a first card and a second processor of a first server, to:
receive data from the storage medium as the storage medium is at least partially inserted into the apparatus, wherein the received data is encoded into the storage medium;
determine that the received data is incomplete;
in response to determining that the received data is incomplete, display a first output requesting authorization to issue a second card;
receive authorization to issue the second card through a user interface;
in response to receiving authorization to issue the second card through the user interface, display a second output requesting data associated with the first card;
receive the requested data through the user interface of the apparatus;
transmit data to a communication network, wherein the transmitted data comprises the user input authorizing issuance of the second card and the requested data associated with the first card;
determine an account associated with a first user that is associated with the first card;
transmit a secondary authorization request for verification to initiate issuance of the second card; and
in response to receiving secondary authorization from the user device, transmit an alert to the user device once the second card has been issued.

16. (canceled)

17. The non-transitory computer-readable medium of claim 15, wherein the secondary authorization request is transmitted through a communication preference based at least in part upon the account associated with the first user.

18. The non-transitory computer-readable medium of claim 17, wherein the communication preference is an email address associated with the account, a phone number associated with the account, or an application on a mobile device associated with the account.

19. The non-transitory computer-readable medium of claim 15, wherein the storage medium is a magstripe disposed on the first card, wherein the instructions are further configured to:
determine that a credit card number was not received from the storage medium, that a security code was not received from the storage medium, that an expiration date was not received from the storage medium, that a portion of the credit card number was not received from the storage medium, that a portion of the authorization code was not received, or that a portion of the expiration date was not received.

20. The non-transitory computer-readable medium of claim 15, wherein the storage medium is contained within a chip disposed on the first card, wherein the instructions are further configured to:
determine that a credit card number was not received from the storage medium, that an authorization code was not received from the storage medium, that a portion of the credit card number was not received from the storage medium, or that a portion of the authorization code was not received.
